(19) United States
(12) Patent Application Publication
(10) Pub. No.: US 2025/0016027 A1
(43) Pub. Date: Jan. 9, 2025

(54) TRI-STATE BUS TRANSMISSION METHOD AND CIRCUIT

(71) Applicant: Infineon Technologies AG, Neubiberg (DE)

(72) Inventors: Dieter Metzner, Eichenau (DE); Eric Pihet, Munich (DE); Stefan Vögele, Munich (DE)

(21) Appl. No.: 18/744,052

(22) Filed: Jun. 14, 2024

(30) Foreign Application Priority Data
Jul. 7, 2023 (DE) 102023118022.3

(51) Int. Cl. H04L 12/40

(52) U.S. Cl. CPC H04L 12/4013; H04L 2012/40215

(57) ABSTRACT

The present application relates to a method for generating a bus transmission signal, which transitions between a dominant state, a suppressive state and a recessive state, and a corresponding circuit. The method comprises receiving a transmission control signal, which transitions between the dominant state and the recessive state, detecting a first state transition of the transmission control signal which is one of a dominant-to-recessive state transition and a recessive-to-dominant state transition and consecutively generating a plurality of transmitter control signals based on the transmission control signal, the first state transition and a plurality of delays and controlling a transmitter to transmit the bus transmission signal based on the plurality of transmitter control signals. The plurality of delays has a sequence tuple comprising a dominant-to-recessive sequence and a recessive-to-dominant sequence and a suppressive delay only included in the dominant-to-recessive sequence, causing the bus transmission signal to remain in the suppressive state.

### TECHNICAL FIELD

The invention generally relates to providing signaling on a bus using a transmission circuit and more precisely to a transmission method and related transmission circuit.

### BACKGROUND

Transmission on a bus in general and on an automotive bus in particular needs to comply with strict signaling requirements regarding various aspects, including but not limited to timing requirements and electromagnetic noise emissions. To this end, transmission circuits with multiple segments may be used, which may for example be arranged in an H-Bridge configuration. Based on these multiple segments, a transmission may be finely tuned in order to comply with the various signaling requirements. However, while multiple segments enable finely tuned transmissions, they also increase the complexity of the control method and circuitry of the transmission circuit, increasing the risk of violating timing requirements and, if a clocked control circuit is used, also the risk of violating electromagnetic noise requirements.

Therefore, it is an objective of the present disclosure to control a multi-segmented transmission circuit in a timely and stable manner.

### SUMMARY OF THE INVENTION

To achieve this objective, the present disclosure provides a method for generating a bus transmission signal to be transmitted by a transmitter including an H-bridge formed by four groups of switches on a bus. The bus transmission signal is configured to transition between a dominant state, a suppressive state and a recessive state. The method comprises receiving a transmission control signal, the transmission control signal being configured to transition between the dominant state and the recessive state, detecting a first state transition of the transmission control signal, the first state transition being one of a dominant-to-recessive state transition and a recessive-to-dominant state transition, consecutively generating a plurality of transmitter control signals based on the transmission control signal, the first state transition and a plurality of delays. The plurality of delays has a sequence tuple, the sequence tuple comprising a dominant-to-recessive sequence corresponding to the dominant-to-recessive state transition and a recessive-to-dominant sequence corresponding to the recessive-to-dominant state transition. Further, the plurality of delays includes a suppressive delay only included in the dominant-to-recessive sequence, the suppressive delay causing the bus transmission signal to remain in the suppressive state during the suppressive delay. Accordingly, consecutively generating the plurality of transmitter control signals includes applying the plurality of delays on the transmission control signal based on the sequence tuple and the first state transition. Finally, the method comprises controlling the four groups of switches to transmit the bus transmission signal based on the plurality of transmitter control signals.

The present disclosure further provides a bus transmission circuit. The bus transmission circuit comprises a transmitter including an H-bridge formed by four groups of switches and configured to provide a bus transmission signal on a bus and a transmission control circuit coupled to the transmitter and configured to receive a transmission control signal, the transmission control signal being configured to transition between the dominant state and the recessive state. The transmission control circuit comprises a transition detection logic configured to detect a first state transition of the transmission control signal, the first state transition being one of a dominant-to-recessive state transition and a recessive-to-dominant state transition and a delay logic comprising a plurality of delay elements and configured to consecutively generate a plurality of transmitter control signals based on the transmission control signal, the first state transition and the plurality of delay elements. The plurality of delay elements has a sequence tuple, the sequence tuple comprising a dominant-to-recessive sequence corresponding to the dominant-to-recessive state transition and a recessive-to-dominant sequence corresponding to the recessive-to-dominant state transition. The plurality of delay elements includes a suppressive delay element only included in the dominant-to-recessive sequence, the suppressive delay element causing the bus transmission signal to remain in the suppressive state while applying the suppressive delay element. Accordingly, to consecutively generate the plurality of transmitter control signals, the delay logic is configured to apply the plurality of delay elements on the transmission control signal in the sequence corresponding to the first state transition. Further, the transmission control circuit is configured to control the four groups of switches to transmit the bus transmission signal based on the plurality of transmitter control signals.

### BRIEF DESCRIPTION OF THE DRAWINGS

Examples of the present disclosure will be described with reference to the following appended drawings, in which like reference signs refer to like elements.

FIG. 1 shows a flow chart of a method for generating a bus transmission signal according to examples of the present disclosure.

FIG. 2 shows a block diagram of a bus transmission circuit according to examples of the present disclosure.

FIG. 3 illustrates a transmitter according to examples of the present disclosure.

FIGS. 4A and 4B illustrate a control signal conversion circuit according to examples of the present disclosure.

FIGS. 5A to 5E illustrate a transmission control circuit and elements thereof according to examples of the present disclosure.

FIGS. 6A and 6B illustrate a bus transmission signal transitioning from a recessive state to a dominant state and corresponding control signals generated by the transmission control circuit of FIGS. 5A to 5E according to examples of the present disclosure.

FIGS. 7A and 7B illustrate a bus transmission signal transitioning from a dominant state to a recessive state and corresponding control signals generated by the transmission control circuit of FIGS. 5A to 5E according to examples of the present disclosure.

FIGS. 8A and 8B illustrate bus transmission signals, control signals contributing to the bus transmission signals and corresponding transmission control signals according to examples of the present disclosure.

It should be understood that the above-identified drawings are in no way meant to limit the present disclosure. Rather, these drawings are provided to assist in understanding the present disclosure. The person skilled in the art will readily understand that aspects of the present invention shown in one drawing may be combined with aspects in another drawing or may be omitted without departing from the scope of the present disclosure.

### DETAILED DESCRIPTION

The present disclosure generally provides a method for generating a bus transmission signal and a corresponding bus transmission circuit based on a transmission control signal.

The bus transmission signal in the context of the present disclosure is considered to have three states: a recessive state, a suppressive state and a dominant state. The recessive state and the suppressive state each correspond to a voltage level of the bus transmission signal corresponding to a logic 0. That is, in terms of logic levels, the recessive state and the suppressive state do not differ from one another. However, in the suppressive state, the transmitter exhibits a higher conductivity, i.e. a lower impedance. The suppressive state may for example be used during a data phase of the bus, i.e. a phase of the bus during which devices coupled to the bus transmit data over the bus. Based on the higher conductivity, i.e. lower impedance compared to the recessive state, the transmitter causes less oscillation during the data phase, thereby enabling compliance with signal integrity requirements of the bus. The dominant state corresponds to a voltage level of the bus transmission signal corresponding to a logic 1. Accordingly, the plurality of transmitter control signals control the segments of the transmitter to transition between these three states, i.e. between logic 0, logic 0 with higher conductivity and logic 1.

The transmission control signal indicates whether the bus transmission signal is to be in the recessive state or in the dominant state. Accordingly, in the context of the present disclosure, the transmission control signal has at least two states: the recessive state, i.e. logic 0, and the dominant state, i.e. logic 1. That is, the transmission control signal is configured to indicate at least two of the three states of the bus transmission signal and thus shares at least two of the three states of the bus transmission signal. To this end, the transmission control signal may transition between the recessive state and the dominant state. Such transitions may thus be referred to as recessive-to-dominant transitions, dominant-to-recessive transitions and more generally as state transitions.

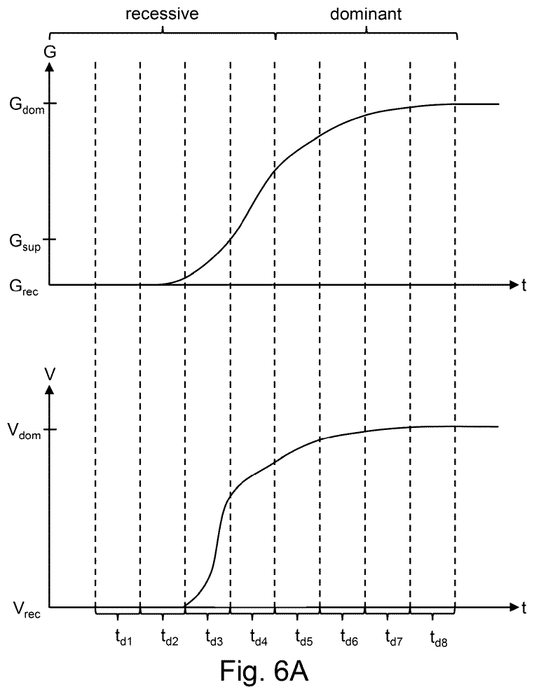

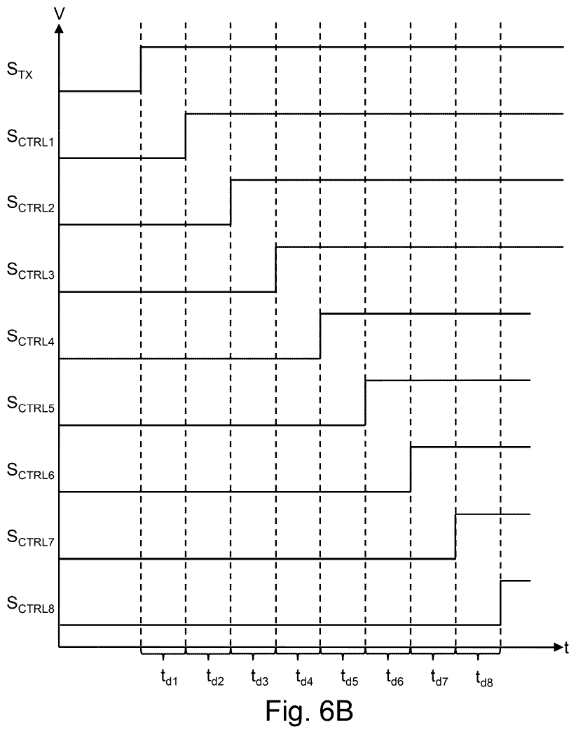

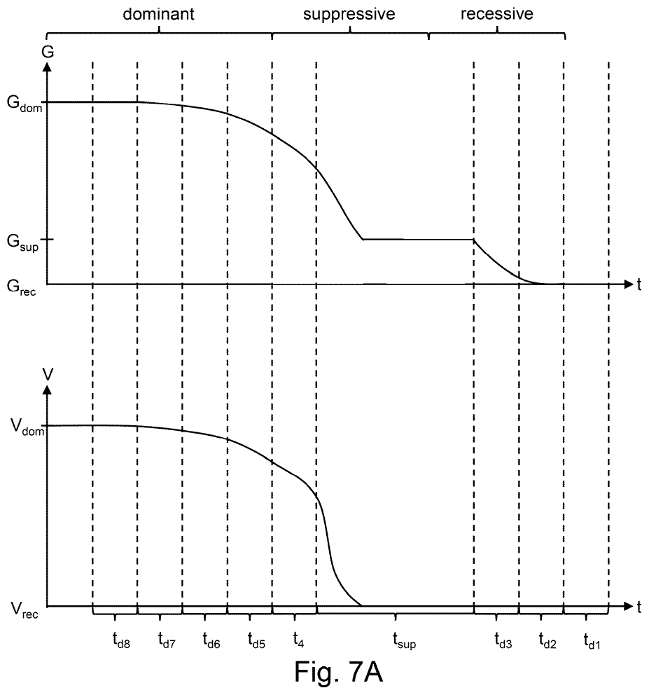

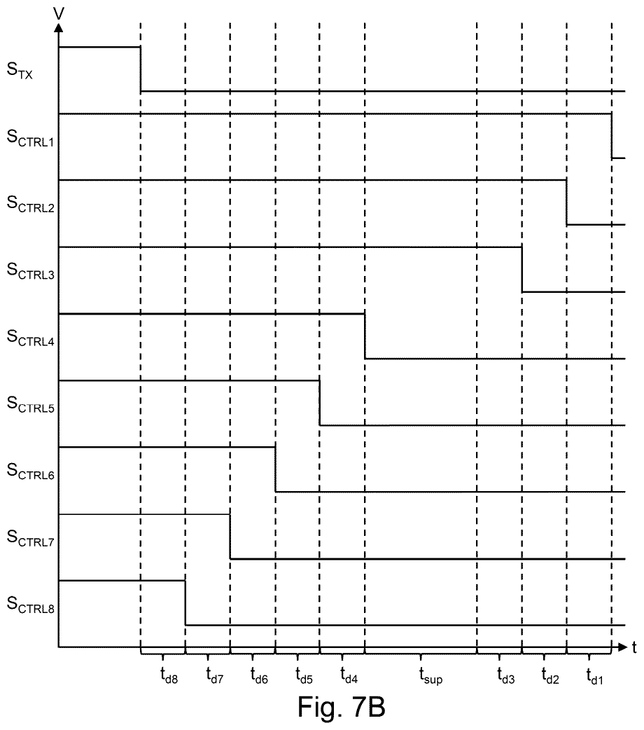

To generate the bus transmission signal based on the transmission control signal, a transmitter with multiple segments is used. The transmitter may e.g. be implemented by four groups of parallel switches arranged as an H-bridge. When a first state transition of the transmission control signal is detected, a plurality of transmitter control signals Is generated to control the multiple segments of the transmitter by applying a plurality of delays to the transmission control signal. In other words, the method takes the transmission control signal and generates the plurality of transmitter control signals as a plurality of delayed copies of the transmission control signal, as e.g. illustrated in FIGS. 6B and 7B. Based on the plurality of transmitter control signals, segments of the transmitter are individually switched, causing the bus transmission signal to transition between the three states, as e.g. illustrated in FIGS. 6A and 7A.

To ensure that the transitions between the three states comply with the timing requirements set by a specification of the bus for the state transitions, the plurality of delays defines time intervals between controlling individual segments of the transmitter and thereby transition times between the three states. In order to transition from the recessive state to the dominant state and vice versa, the plurality of delays includes a sequence tuple, i.e. two orders in which the plurality of delays are applied to the transmission control signal in order to generate the plurality of control signals: a dominant-to-recessive sequence and a recessive-to-dominant sequence. However, while the plurality of delays specifically includes a suppressive delay, i.e. a delay causing the bus transmission signal to remain in the suppressive state for the duration of the suppressive delay, the suppressive delay is only included in the dominant-to-recessive sequence. In other words, when transitioning from the dominant state to the recessive state, the plurality of delays causes the transition from the dominant state to the recessive state to pause at the suppressive state. This may enable the transmitter to return to the dominant state in a timelier manner should a second state transition of the transmission control signal occur, which may instruct the transmitter to return to the bus transmission signal to the dominant state. In terms of transmitted logic value, pausing at the suppressive state does not make a difference with regard to the logic value transmitted, as the suppressive state likewise corresponds to logic 0. In other words, when transitioning from the dominant state to the recessive state, the plurality of delays causes the bus transmission signal to hold at the suppressive state in order to enable a faster return to the dominant state, if instructed to do so by the transmission control signal. Only once the suppressive delay has expired without the second state transition occurring during the suppressive delay does the bus transmission signal start to transition from the suppressive state to the recessive state. The suppressive state in the context of the present disclosure is thus used to enable faster transitions between logic 0 and logic 1 in addition to the above discussed deployment of the suppressive state during the data phase.

To further improve the timing when transitioning from the recessive state or the suppressive state to the dominant state, the method may further generate a plurality auxiliary transmitter control signals upon the detection of a state transition of the transmission control signal from the recessive state to the dominant state. The plurality of auxiliary transmitter control signals may be generated in the same manner as the transmitter control signals, i.e. they may be generated by delaying the transmission control signal. In the case of the plurality of auxiliary transmitter control signals, the transmission control signal is delayed by a plurality of auxiliary delays. The plurality of the auxiliary delays may correspond to the delays of the plurality of delays defining the transition of the bus transmission signal from the recessive state to the suppressive state. The plurality of the auxiliary delays may thus likewise have a recessive-to-dominant sequence and a dominant-to-recessive-order, though the latter may not be used, as will be seen from the discussion of the generation of the plurality of the auxiliary transmitter control signals.

Given that the plurality of auxiliary delays corresponds to the part of the plurality of delays defining the transition between the recessive state and the suppressive state, the plurality of auxiliary transmitter control signals may correspond to the transmitter control signals of the plurality of transmitter control signals causing the transmitter to transition the bus transmission signal from the recessive state to the suppressive state. However, instead of being used to control segments of the transmitter, the plurality of auxiliary transmission control signals is used to be compared to the plurality of transmission control signals.

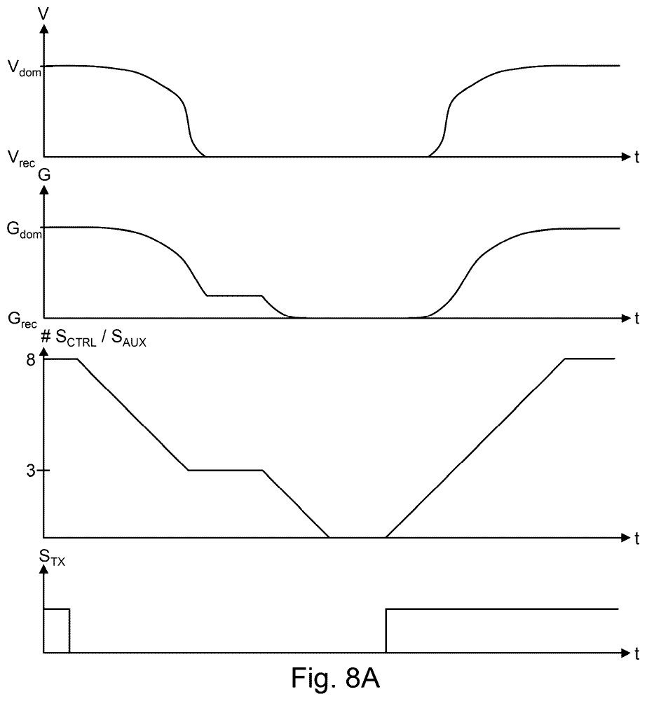

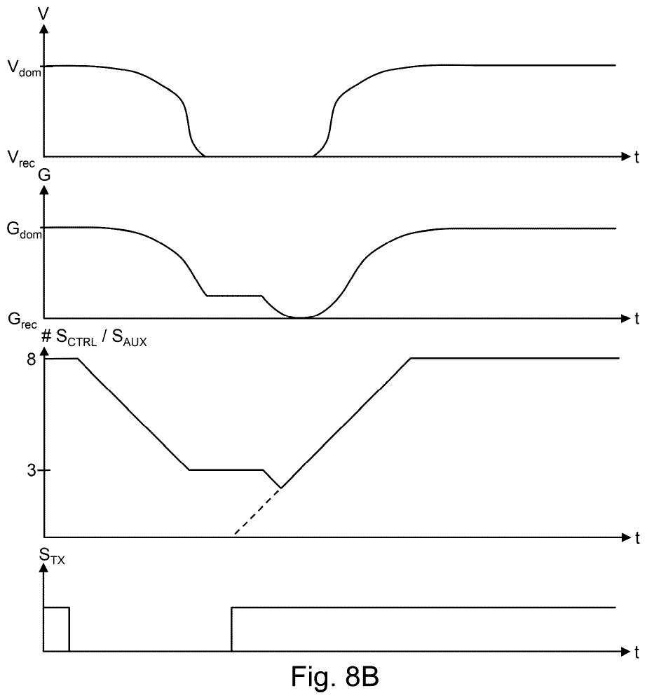

More precisely, upon a transition of the transmission control signal from the recessive state to the dominant state, the generation of the plurality of auxiliary transmitter control signals may start by applying the plurality of auxiliary delays in the recessive-to-dominant sequence. At the same time, the generation of the plurality of transmitter control signals based on the preceding transition of the transmission control signal from the dominant state to the recessive state may continue by applying the plurality of delays in the dominant-to-recessive sequence. While both the plurality of auxiliary transmitter control signals and the plurality of transmitter control signals are generated, the generated auxiliary transmitter control signals and the generated transmitter control signals are compared. Once an auxiliary transmitter control signal is generated based on a delay of the plurality of auxiliary delays corresponding to a delay of the plurality of delays concurrently used to generate a transmitter control signal, the recessive-to-dominant sequence of the plurality of auxiliary delays and the dominant-to-recessive sequence of the plurality of delays is considered to intersect. Once such an intersection is determined, the generation of the plurality of transmitter control signals reverses the sequence in which the plurality of delays is applied to the transmission control signal from the dominant-to-recessive sequence to the recessive-to-dominant sequence. Accordingly, based on the generation of the plurality of auxiliary transmitter control signals and their comparison with the concurrently generated transmitter control signals, the generation of the plurality of transmitter control signals may be reversed before reaching the recessive state (cf. e.g. solid line indicating transmitter control signals and dotted line indicating auxiliary transmitter control signals in FIG. 8B). This may further improve the speed of the bus transmission signal returning to the dominant state in addition to the transition pause described above with regard to the suppressive state.

In addition to the above-described advantages regarding speed when transitioning from the recessive state to the dominant state, the above-describe approach may additionally reduce electromagnetic noise by solely relying on signal delays, signal comparisons and transition detections, which do not require a clock. Given that the multiple segments of the transmitter may be switched in a time range between 1 ns to 100 ns, clock speeds in the GHz range may otherwise be required, which may introduce electromagnetic noise, which may violate the specification of the bus.

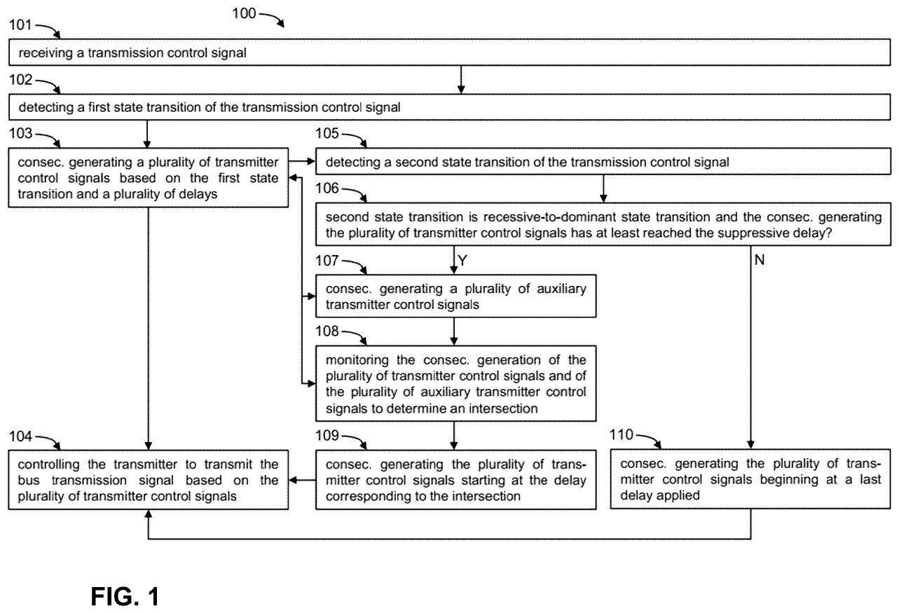

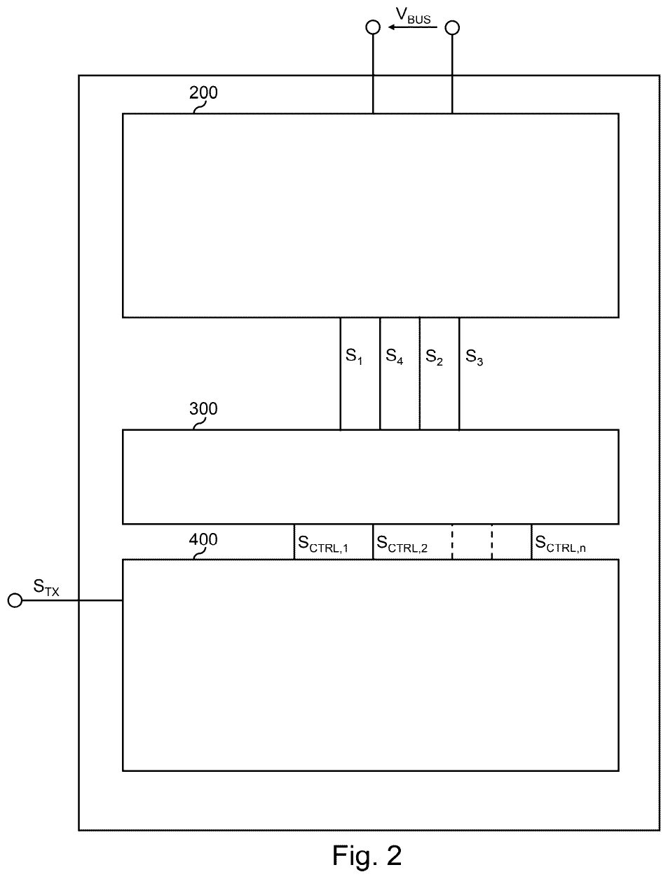

This general concept will be explained with reference to the appended drawings, with FIG. 1 providing a flow-chart of the method for generating the bus transmission signal, FIGS. 2 to 5E illustrating an example implementation of the bus transmission circuit and FIGS. 6A to 8B illustrating signals associated with the method for generating the bus transmission signal and the implementation of the bus transmission circuit.

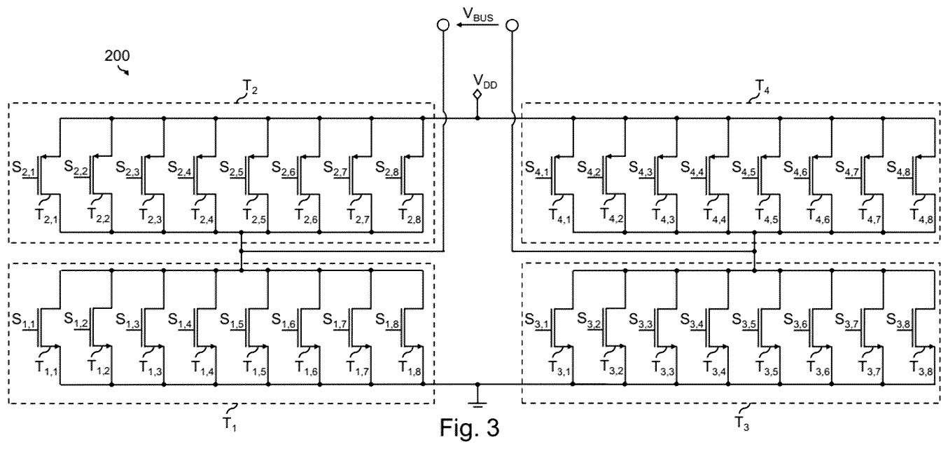

FIG. 1 shows a flow chart of a method 100 for generating the bus transmission signal V_{BUS}. Bus transmission signal V_{BUS} is to be transmitted by a transmitter on a bus. The bus may e.g. be a Controller Area Network (CAN) bus. However, it will be understood that the bus may be any kind of bus defining a logic 0 state, a logic 0 state with higher conductivity and a logic 1 state. The transmitter may be a transmitter with multiple segments, such as example transmitter 200 of FIG. 3.

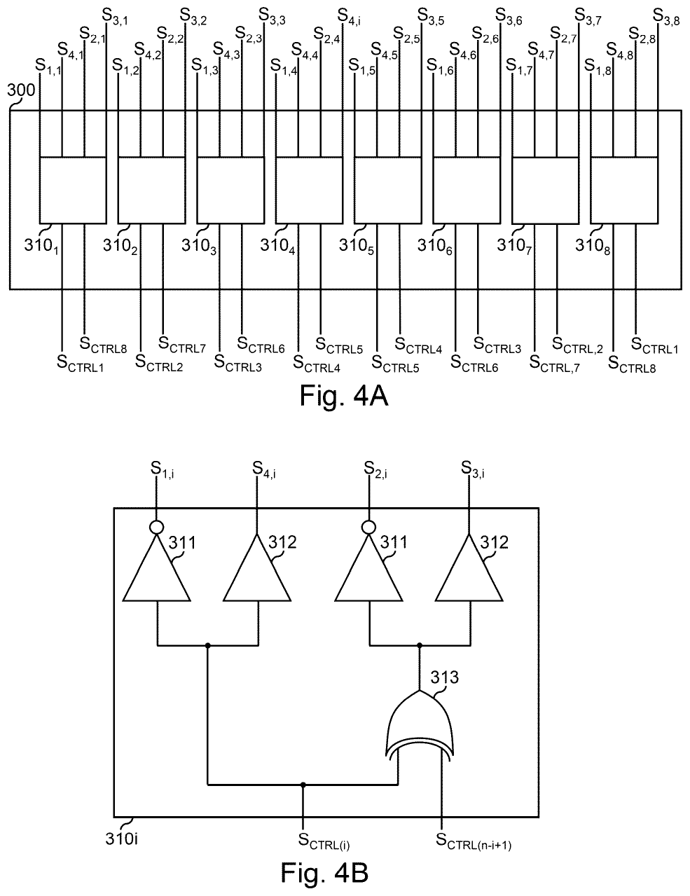

Turning briefly to FIG. 3, transmitter 200 may include an H-bridge formed by four groups of switches T₁ to T₄, which maybe be controlled to output bus transmission signal V_{BUS}. Each group of switches T₁ to T₄ comprises a plurality of transistors coupled in parallel. In the example of FIG. 3, each group of switches T₁ to T₄ includes eight transistors coupled in parallel. However, it will be understood that the groups of switches may include any number of transistors coupled in parallel, such as 40 or 100. Further, the groups of switches T₁ to T₄ may include different numbers of transistors coupled in parallel. For example, group of switches T₂ and group of switches T₃ may include 10 transistors coupled in parallel while groups of switches T₁ and group of switches T₄ include 100 transistors coupled in parallel. Groups of switches T₁ to T₄ may receive control signals S₁ to S₄ at their respective control terminals, which are based on the plurality of transmitter control signals S_{CTRL1} to S_{CTRL8}, as e.g. illustrated in FIG. 4A. Accordingly, groups of switches T₁ to T₄,may be controlled by control signals S₁ to S₄ based on the plurality of transmitter control signals S_{CTRL1} to S_{CTRL8} to output bus transmission signal V_{BUS} as indicated by transmission control signal S_{TX} and may thus transition between the dominant state, the suppressive state and the recessive state discussed above.

Examples of bus transmission signal V_{BUS} transitioning between states are e.g. shown in FIGS. 6A, 7A, 8A and 8B. In FIG. 6A, bus transmission signal V_{BUS} transitions from the recessive state to the dominant state. In FIG. 7A, bus transmission signal V_{BUS} transitions from the dominant state to the recessive state via the suppressive state. FIGS. 8A and 8B show both of these transitions.

In step 101, method 100 receives transmission control signal S_{TX}, which is configured to transition between the dominant state and the recessive state and to thereby instruct transmitter 200 to output bus transmission signal V_{BUS} at the corresponding state and transition between the dominant state and the recessive state, as discussed above. An example of transmission control signal S_{TX} is e.g. shown in FIGS. 6B, FIG. 7B and FIGS. 8A to 8B. Transmission control signal S_{TX} may be provided by a microcontroller or some other kind of logic device configured to communicate over the bus with other devices.

In step 102, method 100 detects a first state transition of transmission control signal S_{TX}, which is one of the dominant-to-recessive state transition and the recessive-to-dominant state transition.

Based on transmission control signal S_{TX} received in step 101 and the first state transition detected in step 102, method 100 in step 103 consecutively generates the plurality of transmitter control signals by applying the plurality of delays on transmission control signal S_{TX}.

As discussed above, the plurality of delays defines time intervals between controlling individual segments of the transmitter, such as individual transistors of one of the groups of switches T₁ to T₄ of transmitter 200, and thereby transition times between the three states of bus transmission signal V_{BUS}. More precisely, the plurality of delays may be defined as shown in equation (1):

$${T}_{D} = \{ {t}_{d 1} , … , {t}_{sup} , … , {t}_{dn} \} \qquad ( 1 )$$

In equation (1), T_{D} denotes the plurality of delays. The plurality of delays T_{D} includes n delays t_{d1} to t_{dn} as well as suppressive delay tₛᵤₚ, which causes bus transmission signal V_{BUS} to remain in the suppressive state during the duration of suppressive delay tₛᵤₚ. Based on plurality of delays T_{D} including n delays, the consecutive generation of the plurality of transmitter control signals generates n transmitter control signals.

To illustrate the concept of conceptually generating n transmitter control signals based on plurality of delays T_{D} including n delays and suppressive delay tₛᵤₚ, an example with n=8 is provided for both the recessive-to-dominant transition as well as the dominant-to-recessive transition in FIGS. 6A and 6B and FIGS. 7A and 7B, respectively.

In FIG. 6A, bus transmission signal V_{BUS} transitions from the recessive state to the dominant state, as illustrated in both the voltage diagram and the conductivity diagram of FIG. 6A and stated at the upper end of the two diagrams. In the voltage diagram, V_{rec} and V_{dom} respectively denote the voltage of bus transmission signal V_{BUS} in the recessive state and in the dominant state. In the conductivity diagram, G_{rec}, Gₛᵤₚ and G_{dom} denote the conductivity of the output of transmitter 200 in the recessive state, the suppressive state and the dominant state. Further, vertical dashed lines indicate the beginning and the end of the eight delays of the exemplary plurality of delays of FIGS. 6A to 7B. The respective delays td1 to td8 are also indicated at the lower end of the two diagrams.

FIG. 6B illustrates transmission control signal S_{TX} causing the recessive-to-dominant transition of bus transmission signal V_{BUS} in FIG. 6A. As can be seen in FIG. 6A, transmission control signal S_{TX} exhibits the recessive-to-dominant transition at the beginning of delay t_{d1}. Upon expiry of delay t_{d1}, transmitter control signal S_{CTRL1} is generated, which corresponds to transmission control signal S_{TX} delayed by delay t_{d1}. Upon expiry of delay t_{d2}, transmitter control signal S_{CTRL2} is generated, which corresponds to transmission control signal S_{TX} delayed by delays t_{d1} and t_{d2}. Upon expiry of delay t_{d3}, transmitter control signal S_{CTRL2} is generated, which corresponds to transmission control signal S_{TX} delayed by delays t_{d1}, t_{d2} and t_{d3}. This process continues until transmitter control signal S_{CTRL8} is generated, which corresponds to transmission control signal S_{TX} delayed by the sum of all delays of the exemplary plurality of delays including eight delays. The plurality of control signals S_{CTRL1} to S_{CTRL8} consecutively generated based on the exemplary plurality of delays including eight delays causes the recessive-to-dominant transition of bus transmission signal V_{BUS} of FIG. 6A, as indicated by the reference to the eight delays at the lower end of the two diagrams.

Analogously to FIG. 6A and FIG. 6B, FIGS. 7A and 7B illustrate the same concept for the dominant-to-recessive transition. That is, FIG. 7B illustrates transmission control signal S_{TX} causing the dominant-to-recessive transition of bus transmission signal V_{BUS} in FIG. 7A. As can be seen in both FIGS. 7A and 7B, when transitioning from the dominant state to the recessive state, bus transmission signal V_{BUS} is kept in the suppressive state during at least part of suppressive delay tₛᵤₚ, as can be seen from the conductivity of transmission signal V_{BUS}, which remains at a suppressive conductivity Gₛᵤₚ for the duration of suppressive delay tₛᵤₚ.

Further, the transmission control signals are generated in the inverse order of FIG. 6B. In other words, transmitter control signal S_{CTRL8} corresponds to transmission control signal S_{TX} delayed by delay t_{d8}, transmitter control signal S_{CTRL7} corresponds to transmission control signal S_{TX} delayed by delays t_{d8} and t_{d7} and so forth. The fact that bus transmission signal V_{BUS} in FIG. 7A is kept in the suppressive state during at least part of suppressive delay tₛᵤₚ is illustrated in FIG. 7B by the fact that transmission control signal S_{CTRL3} is delayed with respect transmission control signal S_{CTRL4} by delay t_{d3} and suppressive delay tₛᵤₚ. As the examples of both FIGS. 6A and 6B as well as FIGS. 7A and 7B illustrate, the consecutive generation of the plurality of transmitter control signals S_{CTRL1} to S_{CTRL8} refers to both the fact that the transmitter control signals are generated one after the other and to the fact that the delay applied to transmission control signal S_{TX} accumulates with each consecutively generated transmitter control signal. In other words, a transmitter control signal S_{CTRLM} corresponds to transmission control signal S_{TX} delayed by the sum of delays t_{d1} to t_{dM}.

In addition, the examples of both FIGS. 6A and 6B as well as FIGS. 7A and 7B illustrate that the plurality of delays has a sequence tuple, i.e. an order in which the plurality of delays are applied to transmission control signal S_{TX} in order to consecutively generate the plurality of transmitter control signals. Given that there are two possible state transitions of transmission control signal S_{TX}, the sequence tuple comprising a dominant-to-recessive sequence corresponding to the dominant-to-recessive state transition and a recessive-to-dominant sequence corresponding to the recessive-to-dominant state transition. The dominant-to-recessive sequence may be defined as shown in equation (2):

$$s e {q}_{D 2 R} = {t}_{d n} , … , {t}_{sup} , … , {t}_{d 1} \qquad ( 2 )$$

Likewise, the recessive-to-dominant sequence may be defined as shown in equation (3):

$$s e {q}_{R 2 D} = {t}_{d 1} , … , {t}_{d n} \qquad ( 3 )$$

As can be seen from equations (2) and (3), the plurality of delays includes suppressive delay tₛᵤₚ only in the dominant-to-recessive sequence. As discussed above, keeping bus transmission signal VBUS in the suppressive state serves the purpose of enabling faster return to the dominant state, i.e. logic 1, from logic 0. Accordingly, suppressive delay tₛᵤₚ is not required in the recessive-to-dominant sequence, which corresponds to a transition from logic 0 to logic 1.

It will be understood that the plurality of delays includes a number of delays corresponding to the number of segments of the transmitter in order to consecutively generate a number of transmitter control signals corresponding to the number of segments. Since the example transmitter 200 includes eight transistors in parallel per group of switch T₁ to T₄, the examples throughout the figures are based on a plurality of delays including eight delays.

As can be seen from the above discussion of the plurality of delays and FIGS. 6A to 7B, the plurality of delays ultimately defines transition times between the three states of bus transmission signal V_{BUS}. Accordingly, a minimum plurality of delays T_{D,min} may be expressed based on equation (1) as shown in equation (4):

$${T}_{D , min} = \{ {t}_{R 2 S} , {t}_{sup} , {t}_{S 2 D} \} \qquad ( 4 )$$

In other words, the plurality of delays may include at least one recessive delay defining a time period corresponding to a transition time between the suppressive state and the recessive state and at least one dominant delay defining a time period corresponding to a transition time between the dominant state and the suppressive state. It will be understood that plurality of delays T_{D,min} represents the smallest possible plurality of delays based on the three states of bus transmission signal V_{BUS}. As mentioned above, the number of delays included in the plurality of delays may correspond to the number of segments of transmitter 200 and may be distributed as needed over the transition from the recessive state to the dominant state and from the dominant state via the suppressive state to the recessive state. That is, a sum of all delays of the plurality of delays in the recessive-to-dominant sequence defines a recessive-to-dominant transition time, a sum of all delays of the plurality of delays in the dominant-to-recessive sequence defines a dominant-to-recessive transition time, and a sum of all delays of the plurality of delays in the dominant-to-recessive sequence from a beginning of the dominant-to-recessive sequence to the suppressive delay defines a dominant-to-suppressive transition time.

While delays t_{d1} to t_{d8} are shown in FIGS. 6A to 7B as defining identical time intervals, it will be understood that the delays of the plurality of delays may define variable delay times, i.e. the delays of the plurality of delays may differ with regard to one another and may have any length as required to define the transition times from the recessive state to the dominant state and from the dominant state via the suppressive state to the recessive state in accordance with the specification of the bus to which the transmitter is coupled. For example, the delays of the plurality of delays may be defined to shorten the transition from the suppressive state to the recessive state or may be defined to keep a slope of bus transmission signal V_{BUS} within a range which is compliant with electromagnetic interference requirements as well as timing requirements of the specification of the bus to which the transmitter is coupled.

In step 104, method 100 controls the four groups of switches to transmit the bus transmission signal based on plurality of transmitter control signals S_{CTRL1} to S_{CTRL8}. In other words, plurality of transmitter control signals S_{CTRL1} to S_{CTRL8} is provided to the various segments of the transmitter, such as the control terminals of the transistors forming transmitter 200, in order to cause the transition of bus transmission signal V_{BUS} in accordance with transmission control signal S_{TX} received in step 101. The four groups of switches may be controlled directly by the plurality of transmitter control signals S_{CTRL1} to S_{CTRL8} or may be translated into control signals, such as control signals S₁ to S₄, as will be discussed with regard to FIGS. 4A and 4B.

Method 100 may include a step 105, in which method 100 detects a second state transition of transmission control signal S_{TX} subsequent to the first state transition, which may again be one of the dominant-to-recessive state transition and the recessive-to-dominant state transition.

Following the detection of the second state transition in step 105, method 100 may proceed to step 106, in which method 100 determines whether the second state transition is the recessive-to-dominant state transition and if the consecutively generating the plurality of transmitter control signals of step 103 has at least reached suppressive delay tₛᵤₚ. In other words, method 100 may determine in step 106 whether transmission control signal S_{TX} indicates that bus transmission signal V_{BUS} is to be in the dominant state while method 100 still performs steps 103 and 104 in order to transition bus transmission signal V_{BUS} from the dominant state to the recessive state. This determination may further include determining which delay is currently being applied in step 103 to generate the plurality of transmission control signals in order to determine if the consecutive generation of the plurality of transmission control signals has already reached or passed suppressive delay tₛᵤₚ, i.e. whether the consecutive generation of the plurality of transmission control signals in step 103 and the corresponding control in step 104 have already reached the suppressive-to-recessive transition of bus transmission signal V_{BUS}.

If step 103 and the corresponding control in step 104 have not yet reached the suppressive-to-recessive transition of bus transmission signal V_{BUS}, method 100 may proceed to step 110, in which method 100 may consecutively generate the plurality of transmitter control signals by applying the plurality of delays on transmission control signal S_{TX} in the recessive-to-dominant sequence beginning at a last delay applied in the dominant-to-recessive sequence. In other words, step 110 corresponds to step 103 with an immediate change of application of the plurality of delays from the dominant-to-recessive sequence to the recessive-to-dominant sequence. Accordingly, method 100 may thus continue performing step 104 based on the consecutive generation of the plurality of transmitter control signals of step 110, as indicated by the arrow pointing from step 110 to step 104 in FIG. 1.

It will be understood that, if step 103 has already applied the last delay of the plurality of delays, i.e. if bus transmission signal has already reached the recessive state following the first transition of transmission control signal S_{TX}, method 100 may perform step 110 by applying the plurality of delays to transmission control signal S_{TX} starting at the first delay of the plurality of delays in the recessive-to-dominant sequence. In other words, if step 103 has already applied the last delay of the plurality of delays step 110 may be performed like step 103 and may in such a case be considered to correspond to step 103.

If step 103 and the corresponding control in step 104 have reached the suppressive-to-recessive transition of bus transmission signal V_{BUS}, method 100 may proceed to steps 107 to 109.

In step 107, method 100 may consecutively generate the plurality of auxiliary transmitter control signals by applying the auxiliary plurality of delays on transmission control signal S_{TX}. As discussed above, the auxiliary plurality of delays corresponds to the delays of the plurality of delays defining the transition from the recessive state to the suppressive state, which are applied in the auxiliary recessive-to-dominant sequence. Returning to the example of FIGS. 6A to 7B, in which the plurality of delays includes eight delays, the auxiliary plurality of delays in this example includes three delays, i.e. all delays of the plurality of delays before suppressive delay.

Accordingly, in this example the plurality of auxiliary transmitter control signals generated in step 107 corresponds to transmitter control signals S_{CTRL1} to S_{CTRL3}. More generally speaking, the plurality of auxiliary transmitter control signals may correspond to the transmitter control signals causing transmitter 200 to transition from the recessive state to the suppressive state. However, unlike the transmitter control signals which are used to control transmitter 200, the plurality of auxiliary transmitter control signals may only be used for the subsequent monitoring in step 108 and not to control the transmitter.

In step 108, method 100 may monitor the consecutive generation of the plurality of transmitter control signals and the consecutive generation of the plurality of auxiliary transmitter control signals to determine an intersection of the auxiliary recessive-to-dominant sequence and the dominant-to-recessive sequence. To this end, method 100 may, as part of step 108, consecutively compare respective delays of the plurality of delays and of the auxiliary plurality of delays being applied to transmission control signal S_{TX} to generate the plurality of transmitter control signals and the plurality of auxiliary transmitter control signals and determine an intersection of the auxiliary recessive-to-dominant sequence and the dominant-to-recessive sequence if generating the plurality of transmitter control signals and generating the plurality of auxiliary transmitter control signals applies corresponding delays of the plurality of delays and of the auxiliary plurality of delays to the transmission control signal. In other words, method 100 may in step 108 compare the generation of the plurality of transmitter control signals and of step 103 and the generation of the plurality of auxiliary transmitter control signals in step 107 to determine when step 103 and step 107 apply corresponding delays of the plurality of delays and of the plurality of auxiliary delays. This comparison is indicated in FIG. 1 by the arrow pointing from step 108 to step 103 and to step 107 and vice-versa.

FIGS. 8A and 8B illustrate the concept of step 110 as well as of steps 107 and 108. To this end, both figures show an exemplary transmission control signal S_{TX}, which exhibits a first state transition from the dominant state to the recessive state and a second state transition from the recessive state to the dominant state. In FIG. 8A, the second state transition of exemplary transmission control signal S_{TX} occurs later than in FIG. 8B. Both figures further illustrate the voltage level and the conductivity level of bus transmission signal V_{BUS} and a dominant state counter indicating the number of transmitter control signals being in the dominant state as a solid line as well as auxiliary transmitter control signals being in the dominant state as a dashed line. Given that the example of both FIGS. 8A and 8B starts with both the bus transmission signal V_{BUS} and exemplary transmission control signal S_{TX} in the dominant state, all transmitter control signals S_{CTRL1} to S_{CTRL8} are initially in the dominant state and transition to the recessive state based on the generation of transmitter control signals and the plurality of delays of step 103. Accordingly, the dominant state counter of the plurality of transmitter control signals decreases as the transmitter control signals consecutively transition to the recessive state.

In FIG. 8A, the second state transition of exemplary transmission control signal S_{TX} instructing bus transmission signal V_{BUS} to return to the dominant state occurs after the last transmission control signal S_{cTRL1} has transitioned to the recessive state. Accordingly, method 100 proceeds from step 105 via step 106 to step 110 to generate the plurality of transmitter control signals starting at the first delay of the plurality of delays in the recessive-to-dominant sequence in order to transition bus transmission signal V_{BUS} to the dominant state. Since step 107 is never triggered, the dominant state counter of the plurality of auxiliary delays remains at zero.

In FIG. 8B, the second state transition of exemplary transmission control signal S_{TX} instructing bus transmission signal V_{BUS} to return to the dominant state occurs during the suppressive delay tₛᵤₚ, as can e.g. be seen in the conductivity diagram as well as the dominant state counter of the plurality of transmitter control signals being held at transmitter control signals S_{cTRL1} to S_{cTRL3} being in the dominant state. Accordingly, method 100 proceeds from step 105 to step 107 via step 106 and starts to consecutively generate auxiliary control signals, as indicated by the dashed line, while still consecutively generating transmitter control signals as part of step 103. As indicated by the increasing dominant state counter of the auxiliary transmitter control signals and the decreasing dominant state counter of the transmitter control signals, steps 103 and 107 continue to generate transmitter control signals based on the first transition and the second transition, respectively, until step 107 determines that both steps 103 and 107 apply delay td2 to generate S_{cTRL2} at the recessive state and a corresponding auxiliary transmitter control signal at the dominant state. This is indicated in the dominant state counter diagram by the solid line and the dashed line intersecting. Accordingly, at this point in time, step 107 determines the intersection of the delay application by steps 103 and 107 and therefore proceeds to step 109.

In step 109, method 100 may consecutively generate the plurality of transmitter control signals by applying the plurality of delays on transmission control signal STX in the recessive-to-dominant sequence starting at the delay of the plurality of delays corresponding to the intersection upon determination of the intersection. This is illustrated in FIG. 8B by the dominant state counter of the plurality of transmitter control signals starting to increase again following the intersection. Based on the consecutive generation of the plurality of transmitter control signals of step 109, method 100 controls bus transmission signal V_{BUS} in step 104 to return to the dominant state, as indicated in FIG. 1 by the arrow pointing from step 109 to step 104 and by bus transmission signal in FIG. 8B returning to the dominant state.

In summary, method 100 generates bus transmission signal V_{BUS} by generating a plurality of transmission control signals following a first transition of transmitter control signal S_{TX} of which correspond to transmitter control signal S_{TX} consecutively delayed by a plurality of delays as discussed with regard to steps 101 to 104. If the first transition is a dominant-to-recessive transition a second transition back to the dominant state occurs, steps 107 and 108 or step 110 may be performed in order to timely return to the dominant state.

It will be understood that voltage levels used in the drawings to indicate recessive and dominant states of the signals are merely provided as an example. Depending on the implementation of the examples of the present disclosure, the dominant state may be represented by logic 0 and the recessive state by logic 1 and vice versa.

Method 100 may be implemented by a bus transmission circuit, as illustrated by the examples of the present disclosure shown in FIGS. 2 to 5E.

FIG. 2 shows an example bus transmission circuit in accordance with the present disclosure, which includes the transmitter having multiple segments, such as transmitter 200 discussed above, a transmission control circuit 400 and may further include a control signal translation logic 300.

Transmission control circuit is configured to implement method 100 of FIG. 1. To this end, transmission control circuit comprises a delay logic 410, and may further comprise auxiliary delay logic 420 and a delay comparison logic 430.

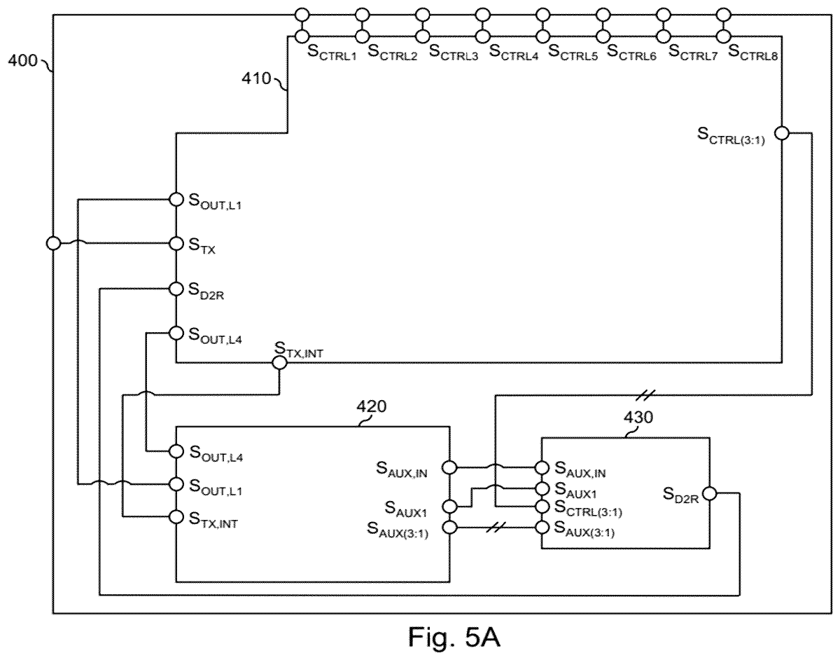

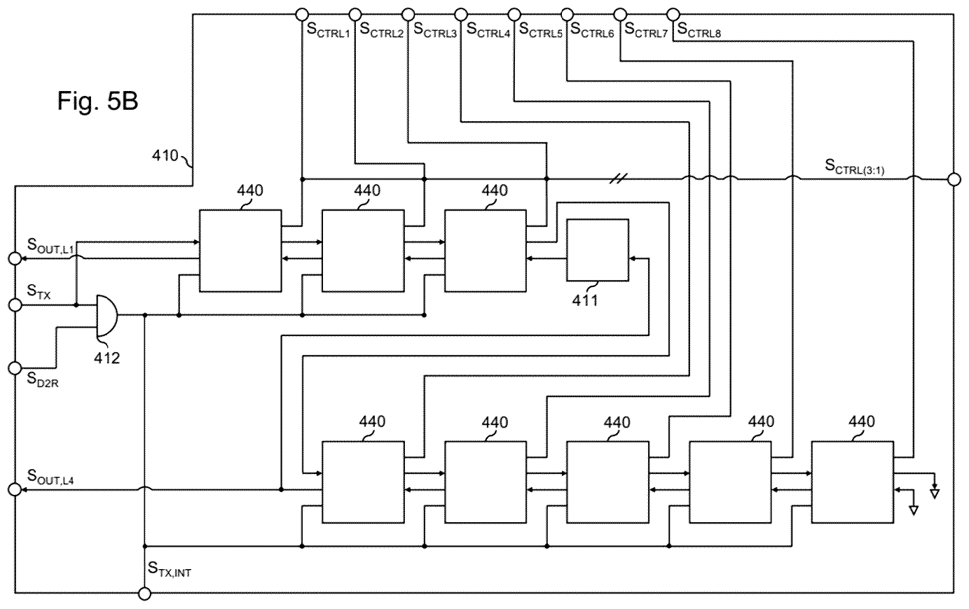

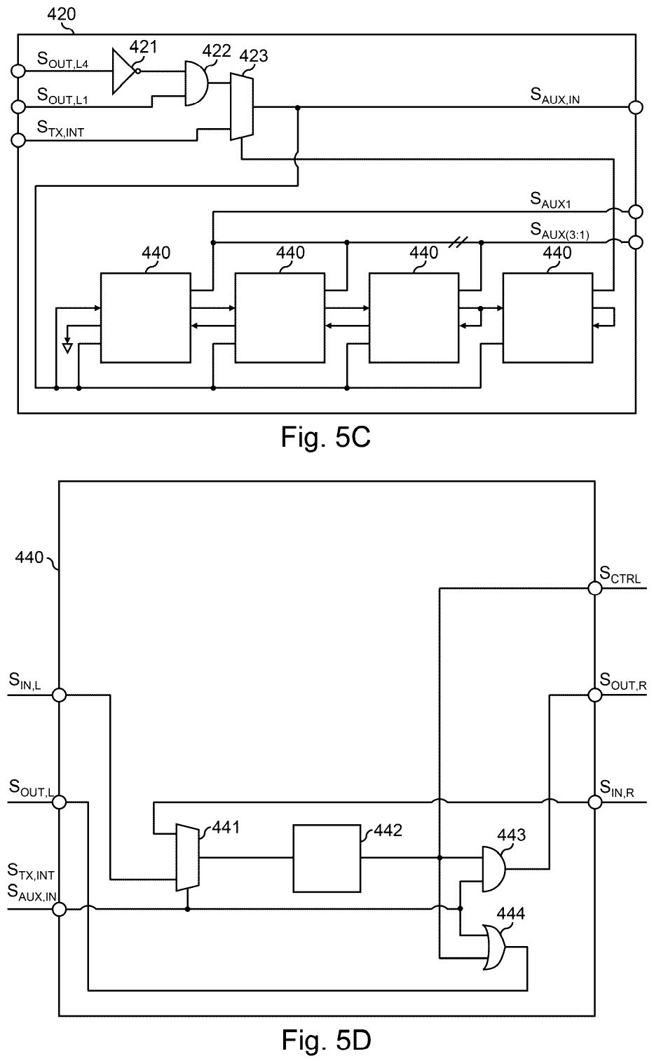

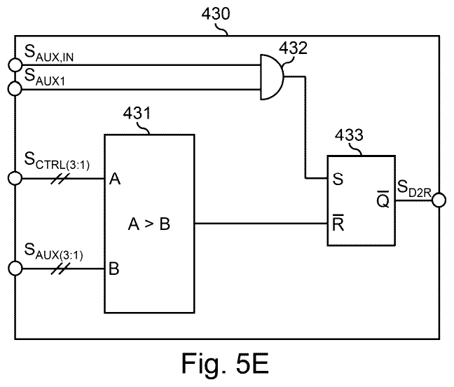

Delay logic 410 is configured to apply the plurality of delays on transmission control signal S_{TX}. Accordingly, delay logic 410 is configured to perform steps 103, 109 and 110 of method 100. To this end, delay logic 410 may comprise a plurality of delay elements corresponding to the above-discussed plurality of delays. Since the examples of the figures are based on an exemplary plurality of delays having eight delays, the example of delay logic 410 in FIG. 5B includes eight delay elements 440 as well as a suppressive delay element 411.

As illustrated in FIG. 5B, the plurality of delay elements 440 may be arranged as a chain of delay elements coupled to one another. More precisely, in order to implement the consecutive generation of the plurality of transmission control signals S_{CTRL1} to S_{CTRL8} in either the recessive-to-dominant sequence or the dominant-to-recessive sequence, each delay element 440 may be coupled via two connections to neighboring delay elements 440. More precisely, each delay element 440 may provide transmission control signal S_{TX} in one of two directions after having applied its delay to transmission control signal S_{TX} in order to implement the consecutive generation of the plurality of transmission control signals S_{CTRL1} to S_{CTRL8} in the currently applicable sequence. Accordingly, transmission control signal S_{TX} and, after the application of the first delay in the currently applicable sequence, the currently generated transmission control signal may propagate from left to right in case of a recessive-to-dominant transition of transmission control signal S_{TX} and may propagate from right to left in case of a dominant-to-recessive transition of bus transmission control signal S_{TX}. The two propagation directions are indicated in FIG. 5B by the arrows on the respective connections. Further, each delay element 440 is configured to receive transmission control signal S_{TX} in order to configure the direction of the propagation direction, i.e. which sequence of the sequence tuple of the plurality of delays is used. Prior to being provided to each delay element 440, transmission control signal S_{TX} may be compared with a dominant-to-recessive-transition signal S_{D2R} by an AND gate 412 in order to change the propagation direction of the plurality of delay elements 440 if the second transition is detected as discussed with regard to steps 105 and 106, i.e. if a second transition is detected while delay logic 410 is still applying the plurality of delays on transmission control signal S_{TX} based on the first transition. If transmission control signal S_{TX} is provided to each delay element 440 based on the output of AND gate 412, the signal provided to each delay element 330 may be referred to as S_{TX,INT}.

To implement suppressive delay tₛᵤₚ, suppressive delay element 411 may be coupled between the third delay element 440 and the fourth delay element 440 in FIG. 5B to delay the transmitter control signals S_{CTRL3} to S_{CTRL1} by suppressive delay tₛᵤₚ, as e.g. illustrated in FIG. 7B. To this end, suppressive delay element 411 may e.g. be implemented by a resistor and a capacitor. Both the resistor and the capacitor may also provide a controllable resistance value and a controllable capacitance value if suppressive delay tₛᵤₚ is to be implemented in a controllable manner. Since suppressive delay tₛᵤₚ is only to be applied in the dominant-to-recessive sequence, suppressive delay element 411 is bypassed in the propagation direction from right to left in delay logic 410.

More generally, suppressive delay element 411 may thus be coupled to the last delay element 440 corresponding to the transition from the dominant state to the suppressive state of bus transmission signal V_{BUS} and to the first delay element 440 corresponding to the transition from the suppressive state to the recessive state of bus transmission signal V_{BUS} but only in the direction corresponding to the dominant-to-recessive-sequence.

Delay logic 410 may provide the plurality of transmitter control signals S_{CTRL1} to S_{CTRL8} directly to transmitter 200 or may, as e.g. shown in FIG. 2, provide the plurality of transmitter control signals S_{CTRL1} to S_{CTRL8} to a translation logic 300. Translation logic 300 may be configured to translate the plurality of transmitter control signals S_{CTRL1} to S_{CTRL8} into control signals S₁ to S₄. Further, delay logic 410 may provide the transmitter control signals corresponding to the transition of bus transmission signal V_{BUS} from the suppressive state to the recessive state, i.e. in the example of FIG. 5B transmitter control signals S_{cTRL1} to S_{CTRL3}, to delay comparison logic 430 as a bus signal S_{CTRL(3:1)} in order to implement steps 105 to 109, if they are to be implemented.

Translation logic 300 may be implemented as shown in FIGS. 4A and 4B. As shown in FIG. 4A, translation logic 300 may include eight pairwise translation units 310₁ to 310₈. Each pairwise translation unit 310ᵢ may translate two transmitter control signals S_{CTRL,i} and S_{CTRL,n-i+1} into four control signals S_{1,i} to S_{4,i}. That is, each pairwise translation unit 310ᵢ may generate a control signal for each of the four groups of switches of transmitter 200. For example, pairwise translation unit 310₁ may translate transmitter control signals S_{CTRL1} and S_{CTRL8} into control signals S_{1,1} to S_{4,1} and pairwise translation unit 310₈ may translate transmitter control signals S_{CTRL8} and S_{CTRL1} into control signals S_{1,8} to S_{4,8}. Each pairwise translation unit 310ᵢ may perform the translation of two transmitter control signals into four control signals as shown in FIG. 4B.

Each pairwise translation unit 310ᵢ may include two inverting amplifiers 311, two non-inverting amplifiers 312 and an XOR gate 313. Based on these elements, each pairwise translation unit 310ᵢ may generate control signal S_{1,i} by inverting and amplifying transmitter control signal S_{CTRL}(i), control signal S_{4,i} by amplifying transmitter control signal S_{CTRL(i)}, control signal S_{2,i} by amplifying and inverting the output of XOR gate 313 and control signal S_{3,i} by amplifying the output of XOR gate 313. XOR gate 313 may receive S_{CTRL(i)} and S_{CTRL,n-i+1}.

Auxiliary delay logic 420 may comprise inverter 421, AND gate 422, multiplexer 423 and a plurality of auxiliary delay elements, which may be implemented by delay elements 440 as previously discussed with regard to delay logic 410. Auxiliary delay logic 420 may implement step 107, i.e. the consecutive generation of the plurality of auxiliary transmitter control signals. To this end, the plurality of auxiliary delay elements may be arranged as a chain of auxiliary delay elements.

The chain of auxiliary delay elements includes a number of delay elements 440 corresponding to the number of delay elements 440 included in delay logic 410 which are configured to generate the transmitter control signals for the transition of bus transmission signal V_{BUS} from the suppressive state to the dominant state, i.e. in the example of FIGS. 5B and 5C the three delay elements applying delays t_{d1} to t_{d3} to transmission control signal S_{TX}. Further, the plurality of auxiliary delay elements includes an additional delay element 440 at the end of the chain of delay elements. The additional delay element may receive the final auxiliary transmitter control signal S_{AUX3}, delay the final auxiliary transmitter control signal S_{AUX3} and provide the delayed final auxiliary transmitter control signal S_{AUX3} as the select signal of multiplexer 423. Accordingly, the chain of auxiliary delay elements 440 of auxiliary delay logic may comprise one delay element more than the delay logic 410 comprises delay elements 440 to generate transmitter control signals causing the transition of bus transition signal V_{BUS} from the suppressive state to the recessive state.

Instead of transmission control signal S_{TX}, each auxiliary delay element 440 may receive an auxiliary delay element input signal S_{AUX,IN}. Auxiliary delay element input signal S_{AUX,IN} may be generated so as to cause auxiliary delay logic 420 to start generating the plurality of auxiliary transmitter control signals S_{AUX1} to S_{AUX3} upon the detection of the second transition of transmission control signal S_{TX} from the recessive state to the dominant state while delay logic 410 is in the process of generating the plurality of transmitter control signals based on the first state transition of transmission control signal S_{TX} from the dominant state to the recessive state which cause the transition of bus transmission signal V_{BUS} from the suppressive state to the recessive state. In the example of FIG. 5B, the transmitter control signals causing the transition of bus transmission signal V_{BUS} from the suppressive state to the recessive state correspond to transmitter control signals S_{CTRL1} to S_{CTRL3}.

To generate auxiliary delay element input signal S_{AUX,IN}, auxiliary delay logic 420 may receive internal transmission control signal S_{TX,INT}, left output signal S_{OUT,L4} and left output signal S_{OUT,L1}. Left output signals S_{OUT,L4} and S_{OUT,L1} correspond to the output of the fourth delay element and the first delay element in the left direction, i.e. in the dominant-to-recessive direction. Further, left output signal S_{OUT,L4} corresponds to transmitter control signal S_{CTRL4}, to which delay logic 410 applies the first delay of the suppressive-to-recessive transition, i.e. delay t_{d3} (cf. FIG. 7B) and left output signal S_{OUT,L1} corresponds to transmitter control signal S_{CTRL1}, i.e. the signal to which delay logic 410 applies the last delay of the suppressive-to-recessive transition of bus transmission signal V_{BUS}, i.e. delay t_{d1} (cf. FIG. 7B). Accordingly, left output signals S_{OUT,L4} and S_{OUT,L1} indicate the beginning and the end of the suppressive-to-recessive transition of bus transmission signal V_{BUS}. Based on these signals, auxiliary delay 420 may generate auxiliary delay element input signal S_{AUX,IN} by inverting left output signal S_{OUT,L4} and comparing inverted left output signal S_{OUT,L4} to signal left output S_{OUT,L1} with AND gate 422. The output of AND gate 422 and internal transmission control signal S_{TX,INT} of delay logic 410 are then provided to multiplexer 423, which may be controlled based on the output of the fourth delay element of the chain of delay elements, as discussed above.

Auxiliary delay logic 420 may further be configured to output auxiliary transmitter control signal S_{AUX1} as well as bus signal S_{AUX(3:1)}, which may combine all auxiliary transmitter control signals of the plurality of auxiliary transmitter control signals as a bus signal.

FIG. 5D provides an example of an implementation of delay element 440 according to examples of the present disclosure, which may be employed in delay logic 410 and auxiliary delay logic 420. As shown, delay element 440 may be configured to receive left input signal S_{IN,L}, right input signal S_{IN,R} and internal transmission control signal S_{TX,INT} if delay element 440 is to be used in delay logic 410, which may be transmission control signal S_{TX} if auxiliary logic 420 and delay comparison logic 430 are not implemented, or auxiliary delay element input signal S_{AUX,IN}, if delay element 440 is to be used in auxiliary delay logic 420. Further, delay element 440 may be configured to output left output signal S_{OUT,L}, right output signal S_{OUT,R} and transmitter control signal S_{CTRL}. Right input signal S_{IN,R} corresponds to the signal provided to delay element 440 in the right propagation direction, i.e. when the plurality of delay elements applies the respective delays in the dominant-to-recessive sequence. Left input signal S_{IN,L} corresponds to the signal provided to delay element 440 in the left propagation direction, i.e. when the plurality of delay elements applies the respective delays in the recessive-to-dominant sequence. Accordingly, left output signal S_{OUT,L} corresponds to the output of delay element when delay element 440 applies its delay on transmission control signal S_{TX} in in the dominant-to-recessive sequence, i.e. when delay element 440 applies its delay on right input signal S_{IN,R}. Right output signal S_{OUT,R} corresponds to the output of delay element when delay element 440 applies its delay on transmission control signal S_{TX} in in the recessive-to-dominant sequence, i.e. when delay element 440 applies its delay on left input signal S_{IN,L}.

To generate left output signal S_{OUT,L}, right output signal S_{OUT,R} and transmitter control signal S_{CTRL} based on left input signal S_{IN,L}, right input signal S_{IN,R} and internal transmission control signal S_{TX,INT}, delay element 440 may include a multiplexer 441, a delay unit 442, an AND gate 443 and an OR gate 443. Multiplexer 443 receives both right input signal S_{IN,R} and left input signal S_{IN,L} and provides one of the two signals to delay unit 442. Transmission control signal S_{TX}, internal transmission control signal S_{TX,INT} or auxiliary delay element input signal S_{AUX,IN} may be provided to multiplexer 441 as the select signal of multiplexer 441.

Accordingly, multiplexer 441 provides right input signal S_{IN,R} to delay unit 442 if transmission control signal S_{TX}, internal transmission control signal S_{TX,INT} or delay element input signal S_{AUX,IN} is in the recessive state. Further, multiplexer 441 provides left input signal S_{IN,L} to delay unit 442 if transmission control signal S_{TX}, internal transmission control signal S_{TX,INT} or auxiliary delay element input signal S_{AUX,IN} is in the dominant state.

Delay element 442 may e.g. be implemented by a resistor and a capacitor. Both the resistor and the capacitor may also provide a controllable resistance value and a controllable capacitance value if suppressive delay the delay of delay element 440 is to be implemented in a controllable manner.

The output of delay element 442 is provided as transmitter control signal S_{CTRL} of delay element 440. In addition, the output of delay element 442 is provided to AND gate 443 and OR gate 444, which both further receive transmission control signal S_{TX}, internal transmission control signal S_{TX,INT} or auxiliary delay element input signal S_{AUX,IN} depending on whether delay element 440 is employed in delay logic 410 and whether auxiliary logic 420 is implemented or whether delay element 440 is to be employed in auxiliary logic 420. The output of AND gate 443 is provided as right output S_{OUT,R}. The output of OR gate 444 is provided as left output S_{OUT,L}. AND gate 443 and OR gate 444 thereby ensure that only a signal having a dominant state is propagated to the right and only a signal having the recessive state is propagated to the left.

FIG. 5E provides an example of delay comparison logic 430. Delay comparison logic 430 may be configured to implement step 108 of method 100, i.e. to monitor the generation of the plurality of transmitter control signals and of the plurality of auxiliary transmitter control signals in order to determine the intersection of the sequence in which the plurality of delays is applied and of the sequence in which the plurality of auxiliary delays is applied. To this end, delay comparison logic 430 may receive auxiliary delay element input signal S_{AUX,IN}, auxiliary transmitter control signal S_{AUX1}, bus signal S_{AUX(3:1)} and bus signal S_{CTRL(3:1)}. Auxiliary delay element input signal S_{AUX,IN} may indicate, if auxiliary delay element input signal S_{AUX,IN} is in the dominant state, that auxiliary logic 420 has started to generate the plurality of auxiliary transmitter control signals. Based on auxiliary delay element input signal S_{AUX,IN}, auxiliary transmitter control signal S_{AUX1}, bus signal S_{AUX(3:1)} and bus signal S_{CTRL(3:1)}, delay logic 430 may generate dominant-to-recessive transition signal S_{D2R}, which may indicate whether a dominant-to-recessive transition of transmission signal S_{TX} has occurred. However, the indication by dominant-to-recessive transition signal S_{D2R} whether a dominant-to-recessive transition of transmission signal S_{TX} has occurred is delayed based on the detection of the intersection by delay comparison logic 430. In other words, delay comparison logic 430 only generates dominant-to-recessive transition signal S_{D2R} as indicating that a dominant-to-recessive transition has occurred once the intersection of the sequence in which the plurality of delays is applied and in which the plurality of auxiliary delays is applied has been determined.

To generate dominant-to-recessive transition signal S_{D2R} as discussed above, delay comparison logic may include a comparison unit 431, an AND gate 432 and a flip-flop 433. Comparison unit 431 may be configured to compare bus signal S_{AUX(3:1)} and bus signal S_{CTRL(3:1)}. As long as bus signal S_{CTRL(3:1)} includes more transmitter control signals in the dominant state than bus signal S_{AUX(3:1)} includes auxiliary transmitter control signals in the dominant state, comparison unit 431 outputs a logic 1. As an example, if transmitter control signals S_{CTRL1} and S_{CTRL2} are in the dominant state and only auxiliary transmitter control signal S_{AUX1} is in the dominant state, comparison unit 431 outputs a logic 1. As a further example, if only transmitter control signal S_{CTRL1} is in the dominant state and auxiliary transmitter control signals S_{AUX1} and S_{AUX2} are in the dominant state, comparison unit 431 outputs a logic 0. Based on this comparison, unit 431 may determine the intersection of the sequence in which the plurality of delays is applied and of the sequence in which the plurality of auxiliary delays is applied. The output of comparison unit 431 is provided to an inverse reset input of flip-flop 433. A set input of flip-flop 433 may receive auxiliary delay element input signal S_{AUX,IN} compared to auxiliary transmitter control signal S_{AUX1} by AND gate 432. Flip-flop 433 may use the set input and the inverse reset input to output dominant-to-recessive transition signal S_{D2R} as defined above.

It will be understood that the implementation of method 100 as shown in FIGS. 2 to 5E is merely provided as an example. Method 100 may be implemented in any way based on the principle of consecutively delaying transmission control signal S_{TX} by the plurality of delays based on the state transition of transmission control signal S_{TX} in order to generate the corresponding transition of bus transmission signal V_{BUS} while employing the suppressive state of bus transmission signal V_{BUS} in order to shorten delay times of state transition of bus transmission signal V_{BUS}.

The invention may further be illustrated by the following examples.

In an example, a method for generating a bus transmission signal to be transmitted by a transmitter including an H-bridge formed by four groups of switches on a bus, wherein the bus transmission signal is configured to transition between a dominant state, a suppressive state and a recessive state, comprises receiving a transmission control signal, the transmission control signal being configured to transition between the dominant state and the recessive state, detecting a first state transition of the transmission control signal, the first state transition being one of a dominant-to-recessive state transition and a recessive-to-dominant state transition, consecutively generating a plurality of transmitter control signals based on the transmission control signal, the first state transition and a plurality of delays, wherein the plurality of delays has a sequence tuple, the sequence tuple comprising a dominant-to-recessive sequence corresponding to the dominant-to-recessive state transition and a recessive-to-dominant sequence corresponding to the recessive-to-dominant state transition, and the plurality of delays includes a suppressive delay only included in the dominant-to-recessive sequence, the suppressive delay causing the bus transmission signal to remain in the suppressive state during the suppressive delay, and consecutively generating the plurality of transmitter control signals includes applying the plurality of delays on the transmission control signal based on the sequence tuple and the first state transition, and controlling the four groups of switches to transmit the bus transmission signal based on the plurality of transmitter control signals.

The example method may further comprise detecting a second state transition of the transmission control signal subsequent to the first state transition, the second state transition being one of the dominant-to-recessive state transition and the recessive-to-dominant state transition and, if the second state transition is the recessive-to-dominant state transition and if the consecutively generating the plurality of transmitter control signals has at least reached the suppressive delay, consecutively generating a plurality of auxiliary transmitter control signals by applying an auxiliary plurality of delays on the transmission control signal, the auxiliary plurality of delays corresponding to delays of the plurality of delays defining a transition from the recessive state to the suppressive state and having an auxiliary recessive-to-dominant sequence, monitoring the consecutive generation of the plurality of transmitter control signals and the consecutive generation of the plurality of auxiliary transmitter control signals to determine an intersection of the auxiliary recessive-to-dominant sequence and the dominant-to-recessive sequence, and consecutively generating the plurality of transmitter control signals by applying the plurality of delays on the transmission control signal in the recessive-to-dominant sequence starting at the delay of the plurality of delays corresponding to the intersection upon determination of the intersection.

In the example method, the monitoring of the consecutive generation of the plurality of transmitter control signals and the consecutive generation of the plurality of auxiliary transmitter control signals may include consecutively comparing respective delays of the plurality of delays and of the auxiliary plurality of delays being applied to the transmission control signal to generate the plurality of transmitter control signals and the plurality of auxiliary transmitter control signals and determining an intersection of the auxiliary recessive-to-dominant sequence and the dominant-to-recessive sequence if generating the plurality of transmitter control signals and generating the plurality of auxiliary transmitter control signals applies corresponding delays of the plurality of delays and of the auxiliary plurality of delays to the transmission control signal.

The example method may further comprise, if the second state transition is the recessive-to-dominant state transition and if the consecutively generating the plurality of transmitter control signals has not reached at least the suppressive delay, consecutively generating the plurality of transmitter control signals by applying the plurality of delays on the transmission control signal in the recessive-to-dominant sequence beginning at a last delay applied in the dominant-to-recessive sequence.

In the example method, the plurality of delays may further include at least one dominant delay defining a time period corresponding to a transition time between the dominant state and the suppressive state, and at least one recessive delay defining a time period corresponding to a transition time between the suppressive state and the recessive state.

In the example method, each delay of the plurality of delays may define a variable delay time.

In the example method, a sum of all delays of the plurality of delays in the recessive-to-dominant sequence may define a recessive-to-dominant transition time, a sum of all delays of the plurality of delays in the dominant-to-recessive sequence may define a dominant-to-recessive transition time, and a sum of all delays of the plurality of delays in the dominant-to-recessive sequence from a beginning of the dominant-to-recessive sequence to the suppressive delay may define a dominant-to-suppressive transition time.

In the example method, the suppressive delay may be less than a bit transmission time of the bus.

In the example method, the bus may be a Controller Area Network (CAN) bus.

An example bus transmission circuit comprises a transmitter including an H-bridge formed by four groups of switches and configured to provide a bus transmission signal on a bus, the bus transmission signal being configured to transition between a dominant state, a suppressive state and a recessive state, and a transmission control circuit coupled to the transmitter and configured to receive a transmission control signal, the transmission control signal being configured to transition between the dominant state and the recessive state, and detect a first state transition of the transmission control signal, the first state transition being one of a dominant-to-recessive state transition and a recessive-to-dominant state transition, wherein the transmission control logic comprises a delay logic comprising a plurality of delay elements and configured to consecutively generate a plurality of transmitter control signals based on the transmission control signal, the first state transition and the plurality of delay elements, wherein the plurality of delay elements has a sequence tuple, the sequence tuple comprising a dominant-to-recessive sequence corresponding to the dominant-to-recessive state transition and a recessive-to-dominant sequence corresponding to the recessive-to-dominant state transition, the plurality of delay elements includes a suppressive delay only included in the dominant-to-recessive sequence, the suppressive delay causing the bus transmission signal to remain in the suppressive state during the suppressive delay, and to consecutively generate the plurality of transmitter control signals the delay logic is configured to apply the plurality of delay elements on the transmission control signal in the sequence corresponding to the first state transition, wherein the transmission control circuit is further configured to control the four groups of switches to transmit the bus transmission signal based on the plurality of transmitter control signals.

In the example bus transmission circuit, the transmission control circuit may further be configured to detect a second state transition of the transmission control signal subsequent to the first state transition, the second state transition being one of the dominant-to-recessive state transition and the recessive-to-dominant state transition, the transmission control circuit may further comprise an auxiliary delay logic comprising a plurality of auxiliary delay elements, the auxiliary plurality of delay elements corresponding to delay elements of the plurality of delay elements defining a transition from the recessive state to the suppressive state and having an auxiliary recessive-to-dominant sequence, the auxiliary delay logic may be configured, if the second state transition is the recessive-to-dominant state transition and if the consecutively generating the plurality of transmitter control signals has at least reached the suppressive delay, to consecutively generate a plurality of auxiliary transmitter control signals by applying the auxiliary plurality of delay elements on the transmission control signal, the transmission control circuit may further comprise a delay comparison logic configured to monitor the consecutive generation of the plurality of transmitter control signals and the consecutive generation of the plurality of auxiliary transmitter control signals to determine an intersection of the auxiliary recessive-to-dominant sequence and the dominant-to-recessive sequence, the delay logic may further be configured to consecutively generate the plurality of transmitter control signals by applying the plurality of delay elements on the transmission control signal in the recessive-to-dominant sequence starting at the delay of the plurality of delay elements corresponding to the intersection upon determination of the intersection.

In the example bus transmission circuit, to monitor the consecutive generation of the plurality of transmitter control signals and the consecutive generation of the plurality of auxiliary transmitter control signals, the delay comparison logic may further be configured to consecutively compare respective delay elements of the plurality of delay elements and of the auxiliary plurality of delay elements being applied to the transmission control signal to generate the plurality of transmitter control signals and the plurality of auxiliary transmitter control signals; and to determine an intersection of the auxiliary recessive-to-dominant sequence and the dominant-to-recessive sequence if generating the plurality of transmitter control signals and generating the plurality of auxiliary transmitter control signals applies corresponding delay elements of the plurality of delay elements and of the auxiliary plurality of delay elements to the transmission control signal.

In the example bus transmission circuit, the delay logic may be configured to, if the second state transition is the recessive-to-dominant state transition and if the consecutively generating the plurality of transmitter control signals has not reached at least the suppressive delay, consecutively generate the plurality of transmitter control signals by applying the plurality of delay elements on the transmission control signal in the recessive-to-dominant sequence beginning at a last delay applied in the dominant-to-recessive sequence subsequent to the second transition.

The preceding description has been provided to illustrate a method for generating a bus transmission signal and a corresponding bus transmission circuit. It should be understood that the description is in no way meant to limit the scope of the present disclosure to the precise embodiments discussed throughout the description. Rather, the person skilled in the art will be aware that the examples of the present disclosure may be combined, modified or condensed without departing from the scope of the present disclosure as defined by the following claims.

1. A method for generating a bus transmission signal to be transmitted by a transmitter including an H-bridge formed by four groups of switches on a bus, wherein the bus transmission signal is configured to transition between a dominant state, a suppressive state and a recessive state, the method comprising:
receiving a transmission control signal, the transmission control signal being configured to transition between the dominant state and the recessive state;
detecting a first state transition of the transmission control signal, the first state transition being one of a dominant-to-recessive state transition and a recessive-to-dominant state transition;
consecutively generating a plurality of transmitter control signals based on the transmission control signal, the first state transition and a plurality of delays, wherein:
the plurality of delays has a sequence tuple, the sequence tuple comprising a dominant-to-recessive sequence corresponding to the dominant-to-recessive state transition and a recessive-to-dominant sequence corresponding to the recessive-to-dominant state transition, and
the plurality of delays includes a suppressive delay only included in the dominant-to-recessive sequence, the suppressive delay causing the bus transmission signal to remain in the suppressive state during the suppressive delay, and
consecutively generating the plurality of transmitter control signals includes applying the plurality of delays on the transmission control signal based on the sequence tuple and the first state transition, and
controlling the four groups of switches to transmit the bus transmission signal based on the plurality of transmitter control signals.

2. The method of claim 1, further comprising:
detecting a second state transition of the transmission control signal subsequent to the first state transition, the second state transition being one of the dominant-to-recessive state transition and the recessive-to-dominant state transition; and
if the second state transition is the recessive-to-dominant state transition and if the consecutively generating the plurality of transmitter control signals has at least reached the suppressive delay:
consecutively generating a plurality of auxiliary transmitter control signals by applying an auxiliary plurality of delays on the transmission control signal, the auxiliary plurality of delays corresponding to delays of the plurality of delays defining a transition from the recessive state to the suppressive state and having an auxiliary recessive-to-dominant sequence;
monitoring the consecutive generation of the plurality of transmitter control signals and the consecutive generation of the plurality of auxiliary transmitter control signals to determine an intersection of the auxiliary recessive-to-dominant sequence and the dominant-to-recessive sequence; and
consecutively generating the plurality of transmitter control signals by applying the plurality of delays on the transmission control signal in the recessive-to-dominant sequence starting at the delay of the plurality of delays corresponding to the intersection upon determination of the intersection.

3. The method of claim 2, wherein the monitoring of the consecutive generation of the plurality of transmitter control signals and the consecutive generation of the plurality of auxiliary transmitter control signals includes:
consecutively comparing respective delays of the plurality of delays and of the auxiliary plurality of delays being applied to the transmission control signal to generate the plurality of transmitter control signals and the plurality of auxiliary transmitter control signals; and
determining an intersection of the auxiliary recessive-to-dominant sequence and the dominant-to-recessive sequence if generating the plurality of transmitter control signals and generating the plurality of auxiliary transmitter control signals applies corresponding delays of the plurality of delays and of the auxiliary plurality of delays to the transmission control signal.

4. The method of claim 2, further comprising:
if the second state transition is the recessive-to-dominant state transition and if the consecutively generating the plurality of transmitter control signals has not reached at least the suppressive delay, consecutively generating the plurality of transmitter control signals by applying the plurality of delays on the transmission control signal in the recessive-to-dominant sequence beginning at a last delay applied in the dominant-to-recessive sequence.

5. The method of claim 1, wherein the plurality of delays further includes:
at least one dominant delay defining a time period corresponding to a transition time between the dominant state and the suppressive state; and
at least one recessive delay defining a time period corresponding to a transition time between the suppressive state and the recessive state.

6. The method of claim 1, wherein each delay of the plurality of delays defines a variable delay time.

7. The method of claim 1, wherein:
a sum of all delays of the plurality of delays in the recessive-to-dominant sequence defines a recessive-to-dominant transition time,
a sum of all delays of the plurality of delays in the dominant-to-recessive sequence defines a dominant-to-recessive transition time, and
a sum of all delays of the plurality of delays in the dominant-to-recessive sequence from a beginning of the dominant-to-recessive sequence to the suppressive delay defines a dominant-to-suppressive transition time.

8. The method of claim 1, wherein the suppressive delay is less than a bit transmission time of the bus.

9. The method of claim 6, wherein the bus is a Controller Area Network -CAN- bus.

10. A bus transmission circuit, comprising:
a transmitter including an H-bridge formed by four groups of switches and configured to provide a bus transmission signal on a bus, the bus transmission signal being configured to transition between a dominant state, a suppressive state and a recessive state; and
a transmission control circuit coupled to the transmitter and configured to:
receive a transmission control signal, the transmission control signal being configured to transition between the dominant state and the recessive state, and
detect a first state transition of the transmission control signal, the first state transition being one of a dominant-to-recessive state transition and a recessive-to-dominant state transition,
wherein the transmission control logic comprises a delay logic comprising a plurality of delay elements and configured to consecutively generate a plurality of transmitter control signals based on the transmission control signal, the first state transition and the plurality of delay elements, wherein:
the plurality of delay elements has a sequence tuple, the sequence tuple comprising a dominant-to-recessive sequence corresponding to the dominant-to-recessive state transition and a recessive-to-dominant sequence corresponding to the recessive-to-dominant state transition,
the plurality of delay elements includes a suppressive delay element only included in the dominant-to-recessive sequence, the suppressive delay element causing the bus transmission signal to remain in the suppressive state while applying the suppressive delay element, and
to consecutively generate the plurality of transmitter control signals, the delay logic is configured to apply the plurality of delay elements on the transmission control signal in the sequence corresponding to the first state transition,
wherein the transmission control circuit is further configured to control the four groups of switches to transmit the bus transmission signal based on the plurality of transmitter control signals.

11. The bus transmission circuit of claim 10, wherein:
the transmission control circuit is further configured to detect a second state transition of the transmission control signal subsequent to the first state transition, the second state transition being one of the dominant-to-recessive state transition and the recessive-to-dominant state transition,
the transmission control circuit further comprises an auxiliary delay logic comprising a plurality of auxiliary delay elements, the plurality of auxiliary delay elements corresponding to delay elements of the plurality of delay elements defining a transition from the recessive state to the suppressive state and having an auxiliary recessive-to-dominant sequence,
the auxiliary delay logic is configured, if the second state transition is the recessive-to-dominant state transition and if the consecutively generating the plurality of transmitter control signals has at least reached the suppressive delay element, to consecutively generate a plurality of auxiliary transmitter control signals by applying the auxiliary plurality of delay elements on the transmission control signal, the transmission control circuit further comprises a delay comparison logic configured to monitor the consecutive generation of the plurality of transmitter control signals and the consecutive generation of the plurality of auxiliary transmitter control signals to determine an intersection of the auxiliary recessive-to-dominant sequence and the dominant-to-recessive sequence, and
the delay logic is further configured to consecutively generate the plurality of transmitter control signals by applying the plurality of delay elements on the transmission control signal in the recessive-to-dominant sequence starting at the delay of the plurality of delay elements corresponding to the intersection upon determination of the intersection.

12. The bus transmission circuit of claim 11, wherein, to monitor the consecutive generation of the plurality of transmitter control signals and the consecutive generation of the plurality of auxiliary transmitter control signals, the delay comparison logic is further configured to:
consecutively compare respective delay elements of the plurality of delay elements and of the auxiliary plurality of delay elements being applied to the transmission control signal to generate the plurality of transmitter control signals and the plurality of auxiliary transmitter control signals; and
determine an intersection of the auxiliary recessive-to-dominant sequence and the dominant-to-recessive sequence if generating the plurality of transmitter control signals and generating the plurality of auxiliary transmitter control signals applies corresponding delay elements of the plurality of delay elements and of the auxiliary plurality of delay elements to the transmission control signal.

13. The bus transmission circuit of claim 11, wherein the delay logic is configured to:
if the second state transition is the recessive-to-dominant state transition and if the consecutively generating the plurality of transmitter control signals has not reached at least the suppressive delay element, consecutively generate the plurality of transmitter control signals by applying the plurality of delay elements on the transmission control signal in the recessive-to-dominant sequence beginning at a last delay applied in the dominant-to-recessive sequence subsequent to the second transition.
